(19) United States
(12) Patent Application Publication
(10) Pub. No.: US 2005/0224165 A1
(43) Pub. Date: Oct. 13, 2005

(54) Method for forming laminated synthetic leather

(76) Inventor: Swei Mu Wang, Taichung (TW)

Correspondence Address: Charles E. Baxley, ESQ, 90 John Street - 3rd Floor, New York, NY, 10038, US

(21) Appl. No.: 10/817,277

(22) Filed: Apr. 1, 2004

(51) Int. Cl. B32B 31/00

(52) U.S. Cl. 156/244.27

(57) ABSTRACT

A method for forming a laminated synthetic leather includes engaging a textile carrier onto a carrying roller, extruding one or more materials with an extruder machine into a film, and feeding the film downwardly onto a lamination roller to have the film carried on a portion of an outer peripheral portion of the lamination roller and to have the film to be suitably cooled by the lamination roller. The film and the textile carrier are then compressed together with the rollers, to form the laminated synthetic leather, and to prevent the film from penetrating into the textile carrier to a greater extent, and to form a soft or flexible laminated synthetic leather.

### BACKGROUND OF THE INVENTION

1. Field of the Invention

The present invention relates to a method, and more particularly to a method for manufacturing or forming laminated synthetic leather.

2. Description of the Prior Art

Typically, for manufacturing or forming laminated synthetic leathers, a soft or melted coating is heated or melted or extruded from an extruder machine into a film, and then pressed onto a textile carrier with rollers, in order to solidly secure the film of the soft or melted coating onto the textile carrier.

For example, German Patent No. DD 298578-A7 to Braun et al. discloses one of the typical extrusion-coating method for pressing a coating of soft polyvinyl chloride (PVC) onto a textile carrier with two rollers. The textile carrier is viscose and heated by contact with a heated lamination roller.

For allowing the soft PVC coating or film to be solidly attached or secured onto the textile carrier, in the compression region between the film of the soft or melted coating and the textile carrier, the PVC film is not initially cooled so much that it loses its thermoplastic workability, and the textile carrier is heated so that the PVC film applied penetrates into the textile carrier to a greater extent.

However, on subsequent cooling, the PVC film loses its workability and flexibility, such that a great portion of the textile carrier will also lose its workability and flexibility, and such that the users may not feel soft or flexible or comfortable when wearing a cloth manufactured with such laminated synthetic leathers.

The present invention has arisen to mitigate and/or obviate the afore-described disadvantages of the conventional methods for manufacturing or forming laminated synthetic leathers.

### SUMMARY OF THE INVENTION

The primary objective of the present invention is to provide a method for manufacturing or forming laminated synthetic leather and for preventing the soft film or coating from penetrating into the textile carrier to a greater extent, and thus for forming a soft or flexible laminated synthetic leather.

In accordance with one aspect of the invention, there is provided a method for manufacturing or forming a laminated synthetic leather, the method comprising providing a carrying roller, engaging a textile carrier onto the carrying roller, providing and disposing a lamination roller close to the carrying roller, providing an extruder machine to extrude a material into a film, downwardly feeding the film onto the lamination roller, to have the film carried on a portion of an outer peripheral portion of the lamination roller, and to have the film to be suitably cooled by the lamination roller, and compressing the film and the textile carrier together with the carrying roller and the lamination roller, to form the laminated synthetic leather, and to prevent the film from being completely penetrated into the textile carrier, or to prevent the soft film or coating from penetrating into the textile carrier to a greater extent, and thus to form a soft or flexible laminated synthetic leather.

The carrying roller may further be arranged or changed relative to the lamination roller, to change an angular position between the carrying roller and the lamination roller.

The extruder machine may further be arranged or changed relative to the lamination roller, to change a position of the film relative to the lamination roller.

The lamination roller may further be cooled to suitably cool the film. For example, a passage may be provided in the lamination roller, and a cooling fluid may be fed through the passage of the lamination roller, to suitably cool the film.

The extruder machine may be changed relative to the lamination roller to different angular positions, to suitably supply the film to the lamination roller. The lamination roller may also be changed to different rotational speeds, in order to change a supporting time of the film on the lamination roller.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view illustrating a method for manufacturing or forming laminated synthetic leather in accordance with the present invention;

FIG. 2 is a plan schematic view illustrating a lamination roller for carrying and cooling a soft film or coating before compression;

FIG. 3 is a cross sectional view showing a laminated synthetic leather to be made with the method for manufacturing or forming laminated synthetic leather in accordance with the present invention;

FIG. 4 is a plan schematic view similar to FIG. 1, illustrating the other arrangement for conduction the method for manufacturing or forming laminated synthetic leather;

FIG. 5 is a plan schematic view similar to FIGS. 1 and 4, illustrating another arrangement for conduction the method for manufacturing or forming laminated synthetic leather;

FIG. 6 is a plan schematic view similar to FIGS. 1 and 4-5, illustrating a further arrangement for conduction the method for manufacturing or forming laminated synthetic leather; and

FIG. 7 is a plan schematic view similar to FIGS. 1 and 4-6, illustrating a still further arrangement for conduction the method for manufacturing or forming laminated synthetic leather.

### DETAILED DESCRIPTION OF THE PREFERRED EMBODIMENT

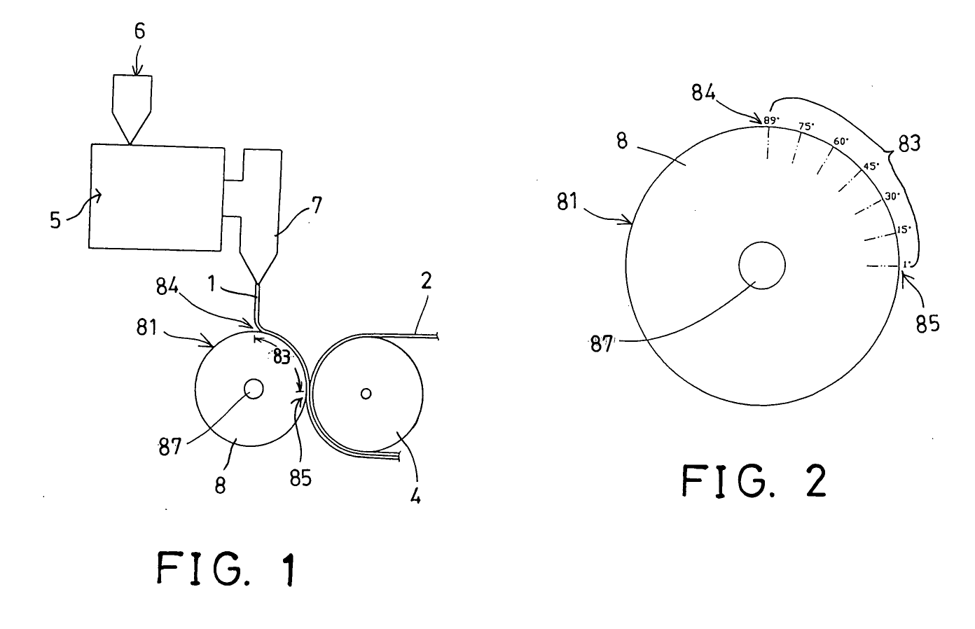

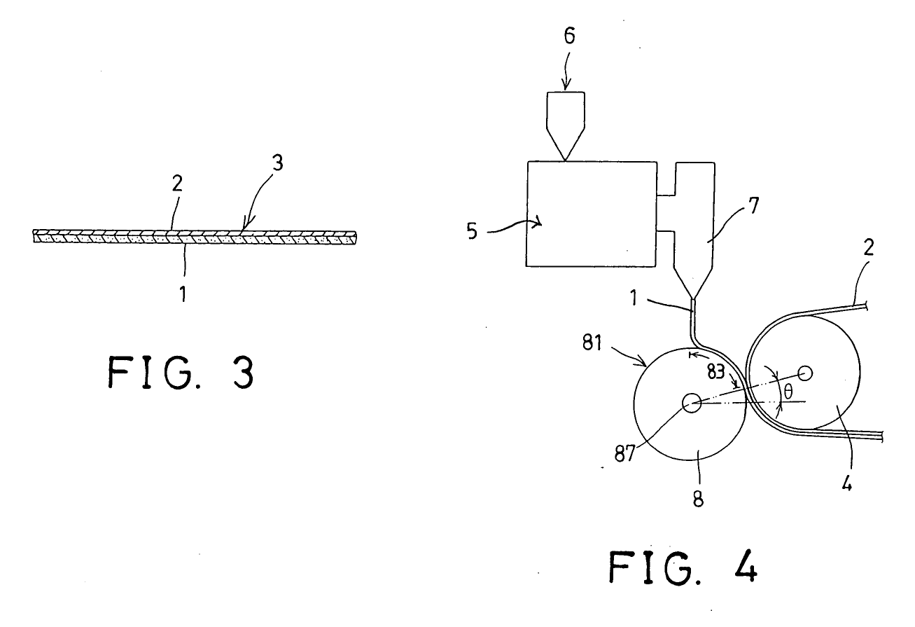

Referring to the drawings, and initially to FIGS. 1-3, a method in accordance with the present invention is provided for attaching or compressing a soft film or coating 1 and a textile carrier 2 together, to form a laminated synthetic leather 3 (FIG. 3), and to prevent the soft film or coating 1 from penetrating into the textile carrier 2 to a greater extent, and thus for forming a soft or flexible laminated synthetic leather 3. A carrying roller 4 is provided to carry the textile carrier 2, and may be made of metal, plastic, rubber or other materials.

An extruder machine 5 is provided to form the soft film or coating 1, and includes an inlet 6 for receiving the materials for forming the soft film or coating 1, and includes a port 7 for outlet the materials that have been heated or melted by the extruder machine 5, to form the soft film or coating 1.

For example, the materials for forming the soft film or coating 1 may be selected from thermoplastic polymers, such as thermoplastic urethane (TPU)+styrene butadiene rubber (SBR); thermoplastic urethane (TPU)+styrene ethylene butylenes styrene block copolymer (SEBS); thermoplastic urethane (TPU)+thermoplastic rubber (TPR); thermoplastic urethane (TPU)+ethylene propylene diene monomer rubber (EPDM); or the like.

The inclusion or the introducing of the other materials, such as styrene butadiene rubber (SBR), styrene ethylene butylenes styrene block copolymer (SEBS), thermoplastic rubber (TPR), ethylene propylene diene monomer rubber (EPDM) into the thermoplastic urethane (TPU) is provided to change the characteristics of the thermoplastic urethane (TPU), in order to form the soft film or coating 1 having a porous structure or having a number of perforations formed therein. A foamable agent may further be added or introduced into the materials for forming the soft film or coating 1, in order to increase the softness or the flexibility of the film or coating 1.

A lamination roller 8 is further provided and disposed close to the carrying roller 4, and includes an outer peripheral portion 81 to support and to carry the soft film or coating 1, and is preferably made of heat conductive materials, such as metal, for contacting with the heated or melted soft film or coating 1. A segment 83 of the outer peripheral portion 81 of the lamination roller 8 is contacted with the heated or melted soft film or coating 1, to suitably dissipate the heat of the heated or melted soft film or coating 1.

For example, as shown in FIGS. 1 and 2, it is preferably that the heated or melted soft film or coating 1 is flowing or feeding downwardly out of or from the port 7 of the extruder machine 5, to engage with a top point or an end 84 of the segment 83 that is designed with 89° of the lamination roller 8, and engaged with the segment 83 of the outer peripheral portion 81 of the lamination roller 8, and then leaving at a lateral point or another end 85 of the segment 83 that is designed with 1° of the lamination roller 8. Accordingly, the lamination roller 8 is preferably controlled and limited to rotate within a rotational or moving stroke of about 89 degrees.

In addition to suitably cooling the heated or melted soft film or coating 1, the lamination roller 8 may also be used to suitably support the heated or melted soft film or coating 1, to allow the heated or melted soft film or coating 1 to have a uniformly distributed thickness, or to prevent the heated or melted soft film or coating 1 from having a changing thickness.

The lamination roller 8 preferably includes a passage 87 formed or provided therein for receiving cooling water or fluid therethrough, and for allowing the lamination roller 8 and thus the heated or melted soft film or coating 1 to be suitably cooled by the cooling water or fluid flowing through the passage 87 of the lamination roller 8.

It is to be noted that the flowing speed of the cooling water or fluid flowing through the passage 87 of the lamination roller 8 may be controlled to determine the temperature of the heated or melted soft film or coating 1, for allowing the heated or melted soft film or coating 1 to be suitably pressed onto the textile carrier 2. The rotational speed of the lamination roller 8 may also be controlled to change the supporting time of the film 1 on the roller 8 and to determine the temperature of the heated or melted soft film or coating 1.

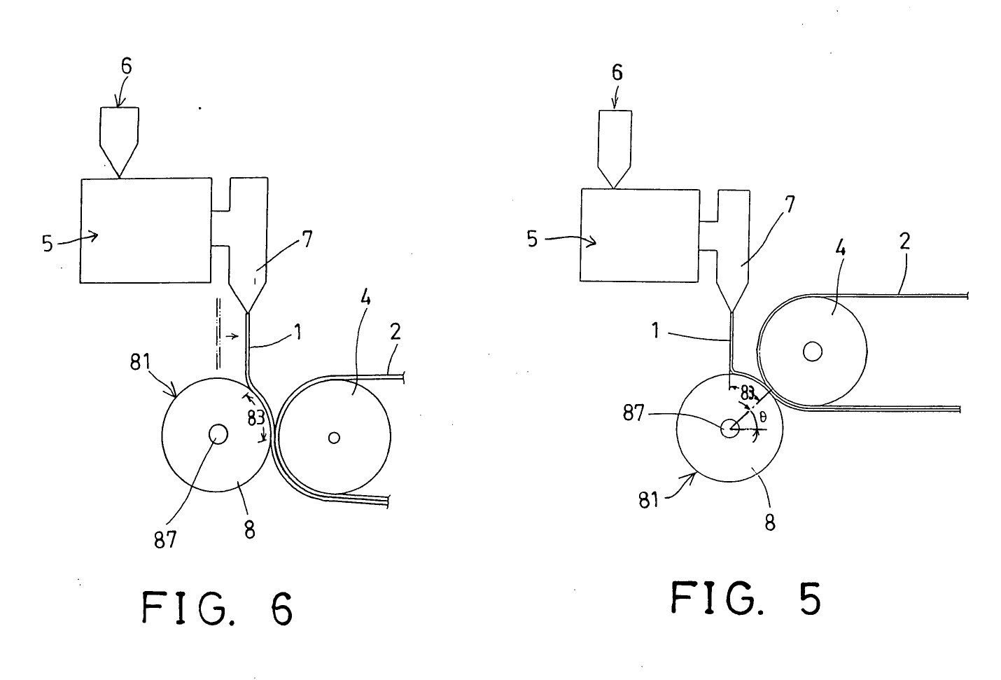

As shown in FIG. 1, the rollers 4, 8 may be disposed side by side, to allow the heated or melted soft film or coating 1 to be carried on all of the segment 83 of the outer peripheral portion 81 of the lamination roller 8. Alternatively, as shown in FIGS. 4 and 5, the carrying roller 4 may also be disposed or arranged in different angular position relative to the lamination roller 8, to change the engaging portion of the heated or melted soft film or coating 1 with the segment 83 of the outer peripheral portion 81 of the lamination roller 8.

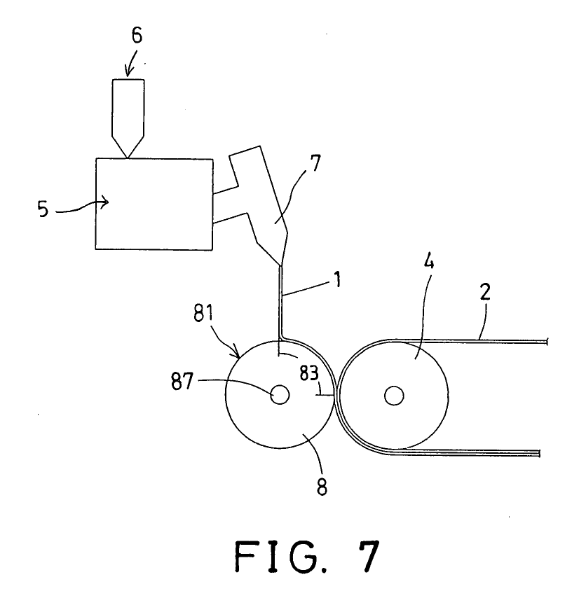

Further alternatively, as shown in FIG. 6, the port 7 of the extruder machine 5 may also be changed to different position relative to the lamination roller 8, to change the engaging portion of the downwardly fed film or coating 1 with the segment 83 of the outer peripheral portion 81 of the lamination roller 8. As shown in FIG. 7, the port 7 of the extruder machine 5 may also be changed to different angular position relative to the lamination roller 8, to suitably supply the film or coating 1 toward the lamination roller 8.

After the heated or melted soft film or coating 1 has been suitably cooled to the required temperature by the lamination roller 8 and/or the cooling water or fluid, the film 1 and the textile carrier 2 may be compressed together by the rollers 4, 8, in order to form the laminated synthetic leather 3 (FIG. 3). In addition, the suitably cooled film 1 may be prevented from completely or fully penetrated into the textile carrier 2 to a greater extent.

For example, the film 1 may be penetrated into the textile carrier 2 to an extent of about 3-45 vol. %, for allowing the laminated synthetic leather 3 to have a suitable softness or flexibility. The outer peripheral portion 81 of the lamination roller 8 may be formed into a smooth outer surface or may be formed or knurled with various patterns to have the patterns to be transferred or formed on the laminated synthetic leather 3.

Accordingly, the method in accordance with the present invention may be used for preventing the soft film or coating from penetrating into the textile carrier to a greater extent, and thus for forming a soft or flexible laminated synthetic leather.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A method for manufacturing or forming a laminated synthetic leather, said method comprising:
providing a carrying roller,
engaging a textile carrier onto said carrying roller,
providing and disposing a lamination roller close to said carrying roller,
providing an extruder machine to extrude a material into a film,
downwardly feeding said film onto said lamination roller, to have said film carried on a portion of an outer peripheral portion of said lamination roller, and to have said film to be suitably cooled by said lamination roller, and
compressing said film and said textile carrier together with said carrying roller and said lamination roller, to form said laminated synthetic leather, and to prevent said film from being completely penetrated into said textile carrier.

2. The method as claimed in claim 1 further comprising arranging said carrying roller relative to said lamination roller, to change an angular position between said carrying roller and said lamination roller.

3. The method as claimed in claim 1 further comprising changing said extruder machine relative to said lamination roller, to change a position of said film relative to said lamination roller.

4. The method as claimed in claim 1 further comprising cooling said lamination roller, to suitably cool said film.

5. The method as claimed in claim 4 further comprising, providing a passage in said lamination roller, and feeding a cooling fluid through said passage of said lamination roller, to suitably cool said film.

6. The method as claimed in claim 1 further comprising changing an angular position of said extruder machine relative to said lamination roller, to suitably supply said film to said lamination roller.

7. The method as claimed in claim 1 further comprising changing a rotational speed of said lamination roller, to change a supporting time of said film on said lamination roller.

8. The method as claimed in claim 1 further comprising introducing a foamable agent into said material for forming said film, and for increasing a softness of said film.

9. The method as claimed in claim 1 further comprising forming said film into a porous structure having a plurality of perforations formed therein.

10. The method as claimed in claim 1 further comprising limiting said carrying roller to move within a rotational moving stroke of eighty nine degrees.

11. The method as claimed in claim 1, wherein said material is selected from thermoplastic polymers.

12. The method as claimed in claim 1, wherein said thermoplastic polymers materials are thermoplastic urethane (TPU)+styrene butadiene rubber (SBR).

13. The method as claimed in claim 1, wherein said thermoplastic polymers materials are thermoplastic urethane (TPU)+styrene ethylene butylenes styrene block copolymer (SEBS).

14. The method as claimed in claim 1, wherein said thermoplastic polymers materials are thermoplastic urethane (TPU)+thermoplastic rubber (TPR).

15. The method as claimed in claim 1, wherein saidc thermoplastic polymers materials are thermoplastic urethane (TPU)+ethylene propylene diene monomer rubber (EPDM).

16. A method for manufacturing or forming a laminated synthetic leather, said method comprising:
providing a carrying roller,
providing and disposing a lamination roller close to said carrying roller,
engaging a textile carrier onto said carrying roller,
providing an extruder machine to extrude a material into a film,
feeding said film onto said lamination roller, to have said film carried on a portion of an outer peripheral portion of said lamination roller, and to have said film to be suitably cooled by said lamination roller, and
compressing said film and said textile carrier together with said carrying roller and said lamination roller, to form said laminated synthetic leather, and to prevent said film from being completely penetrated into said textile carrier.
